(19) United States
(12) Patent Application Publication
(10) Pub. No.: US 2022/0048496 A1
(43) Pub. Date: Feb. 17, 2022

(54) APPARATUS AND METHOD FOR CONTROLLING THE OPERATIONS OF CONTROLLED DEVICES WITHIN A VEHICLE

(71) Applicant: Lear Corporation, Southfield, MI (US)

(72) Inventors: Francesco Migneco, Saline, MI (US); David Gallagher, Sterling Heights, MI (US); Sajad Arabnejad, Ann Arbor, MI (US); Samuel Hanlon, Northville, MI (US)

(73) Assignee: Lear Corporation, Southfield, MI (US)

(21) Appl. No.: 16/993,355

(22) Filed: Aug. 14, 2020

(51) Int. Cl. B60W 30/00; B60W 50/14

(52) U.S. Cl. CPC B60W 30/00; B60R 16/023; B60W 50/14

(57) ABSTRACT

An apparatus for controlling the operation of a controlled device in a vehicle includes a vehicle including a vehicle sensor. A vehicle module receives a signal from the vehicle sensor, and a controlled device receives a signal from the vehicle module for controlling the operation of the controlled device. A personal peripheral device includes a personal peripheral device sensor and a processor that is configured to receive a signal from both the personal peripheral device sensor and the vehicle module. Based upon those signals, the personal peripheral device processor generates a signal to the vehicle module for generating the signal from the vehicle module for controlling the operation of the controlled device.

### BACKGROUND OF THE INVENTION

This invention relates in general to apparatuses and methods for controlling the operations of one or more controlled devices in a vehicle. In particular, this invention relates to an improved apparatus and method for controlling the operations of one or more controlled devices in a vehicle using a personal peripheral device, such as a smartphone, a smartwatch, and the like.

To promote increased comfort, convenience, and safety for occupants, most modern vehicles include one or more sensors that measure predetermined operating conditions within or about the vehicle. For example, most vehicles include sensors that measure velocity, acceleration, cabin temperature, outside temperature, and the like. Each of these sensors generates electronic signals that are representative of the associated sensed operating conditions. Additionally, most modern vehicles include one or more user input controls that can be manipulated by a driver or a passenger to regulate the operation of respective controlled devices within or about the vehicle. For example, most vehicles include user input controls that regulate the operation of heating, ventilating, and/or cooling devices, audio and/or video devices, and the like. Each of these user input controls also generates electronic signals that are representative of the desired operations of the associated controlled devices. A wide variety of such sensors and user input controls are known in the art.

In order for these sensors and user input controls to be effective, the electronic signals generated therefrom must be processed by an electronic controller. In the past, these electronic signals have been processed by one or more electronic control modules that are provided as original equipment within the vehicle. In response to the electronic signals from the sensors and the user input controls, the electronic control modules determine one or more actions that should be taken by the controlled devices. To accomplish this, the electronic control modules send control signals to the controlled devices, which cause them to operate in the desired manners.

As the number of sensors and user input controls within modern vehicles has increased, so have the amount of electronic signals required to be processed by the electronic control modules. However, each of the electronic control modules provided within the vehicle has a finite capacity for processing the electronic signals from the sensors and the user input controls. Consequently, as more processing capacity is required, additional electronic control modules must be provided as original equipment within the vehicles. Unfortunately, each additional electronic control module adds cost and complexity to the vehicle. Thus, it would be desirable to increase the processing capacity for these electronic signals without requiring that additional electronic control modules be provided as original equipment within the vehicle.

### SUMMARY OF THE INVENTION

This invention relates to an improved apparatus and method for controlling the operations of one or more controlled devices in a vehicle using a personal peripheral device, such as a smartphone, a smartwatch, and the like. The apparatus includes a vehicle including a vehicle sensor. A vehicle module receives a signal from the vehicle sensor, and a controlled device receives a signal from the vehicle module for controlling the operation of the controlled device. A personal peripheral device includes a personal peripheral device sensor and a processor that is configured to receive a signal from both the personal peripheral device sensor and the vehicle module. Based upon those signals, the personal peripheral device processor generates a signal to the vehicle module for generating the signal from the vehicle module for controlling the operation of the controlled device.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a block diagram of a conventional apparatus for controlling the operations of one or more controlled devices in a vehicle.

FIG. 2 is a flowchart showing the steps performed in a method for operating the conventional apparatus illustrated in FIG. 1.

FIG. 3 is a block diagram of a first embodiment of an improved apparatus for controlling the operations of one or more controlled devices in a vehicle in accordance with this invention.

FIG. 4 is a flowchart showing the steps performed in a method for operating the first embodiment of the improved apparatus illustrated in FIG. 3.

FIG. 5 is a flowchart showing the steps performed in an alternative method for operating the first embodiment of the improved apparatus illustrated in FIG. 3.

FIG. 6 is a block diagram of a second embodiment of an improved apparatus for controlling the operations of one or more controlled devices in a vehicle in accordance with this invention.

### DETAILED DESCRIPTION OF THE PREFERRED EMBODIMENTS

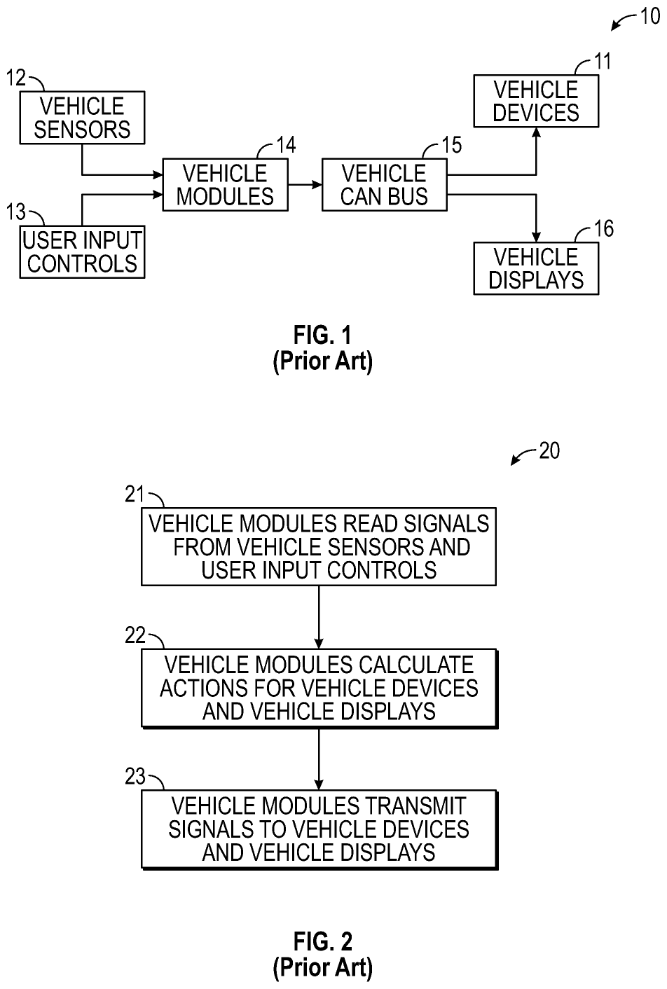

Referring now to the drawings, there is illustrated in FIG. 1 is a block diagram of an apparatus, indicated generally at 10, that is conventional in the art for controlling the operations of one or more controlled devices 11 in a vehicle. The prior art apparatus 10 includes one or more sensors 12 that measure respective operating conditions within or about the vehicle. For example, the vehicle sensors 12 may include sensors that measure velocity, acceleration, cabin temperature and humidity, outside temperature and humidity, seat occupancy, driver biometrics (such as eye movement, blood pressure, heart rate, breathing rate, and electro-dermal potential), and the like. Each of these sensors 12 generates electronic signals that are representative of the associated sensed operating conditions. Additionally, the prior art apparatus 10 includes one or more user input controls 13 that can be manipulated by a driver or a passenger to regulate the operation of the respective controlled devices 11 within or about the vehicle. For example, the user input controls 13 may include switches or other devices that regulate the operation of heating, ventilating, and/or cooling devices, audio and/or video devices, and the like. Each of these user input controls 13 also generates electronic signals that are representative of the desired operations of the associated controlled devices 11.

The prior art apparatus 10 also includes one or more conventional electronic control modules 14 (known as vehicle modules) that receive the electronic signals from the sensors 12 and the user input controls 13. The vehicle modules 14 may be provided as original equipment within the vehicle. In response to the electronic signals from the sensors 12 and the user input controls 13, the vehicle modules 14 determine one or more actions that should be taken by one or more of the controlled devices 11. To accomplish this, the vehicle modules 14 send control signals to the controlled devices 11 by means of a vehicle controller area network (CAN) bus 15 or other conventional communications network provided within the vehicle. The controlled devices 11 receive the control signals from the vehicle modules 14, which cause the controlled devices 11 to operate in the desired manners. Additionally, the control signals from the vehicle modules 14 may be sent to one or more conventional display devices 16 provided within the vehicle. These display devices 16 may be used to display a variety of information, such as the operating conditions within or about the vehicle as determined by the sensors 12, the operational statuses of the user input controls 13, and the operational statuses of the controlled devices 11.

FIG. 2 is a flowchart showing the steps performed in a conventional method, indicated generally at 20, for operating the conventional apparatus 10 illustrated in FIG. 1. In a first step 21 of the method 20, the vehicle modules 14 initially read the various signals that are generated by the vehicle sensors 12 and the user input controls 13. Then, in a second step 22 of the method 20, the vehicle modules 14 calculate one or more actions to be implemented in the vehicle devices 11 and/or the vehicle displays 16. Such calculations are performed in accordance with a predetermined algorithm in response to the various signals from the vehicle sensors 12 and the input controls 13. Lastly, in a third step 23 of the method 20, the vehicle modules 14 transmit the calculated action signals to the vehicle devices 11 and/or the vehicle displays 16 for implementation.

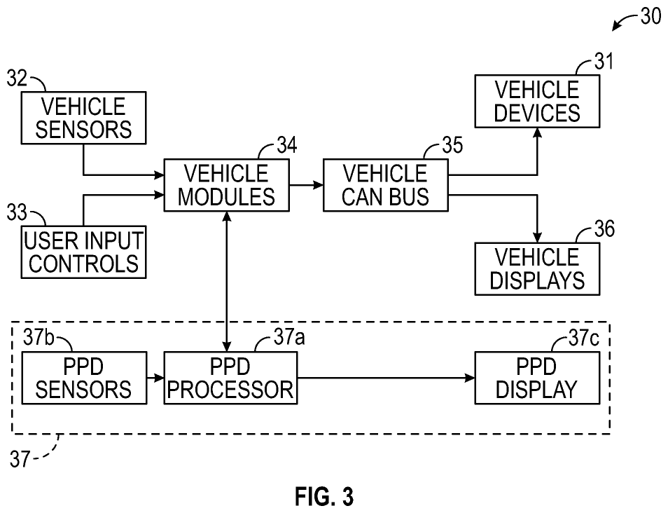

FIG. 3 is a block diagram of a first embodiment of an apparatus, indicated generally at 30, for controlling the operations of one or more controlled devices 31 in a vehicle in accordance with this invention. The first embodiment of the apparatus 30 includes one or more sensors 32 that measure respective operating conditions within or about the vehicle. For example, the vehicle sensors 32 may include sensors that measure velocity, acceleration, cabin temperature and humidity, outside temperature and humidity, seat occupancy, driver biometrics (such as eye movement, blood pressure, heart rate, breathing rate, and electro-dermal potential), and the like. Each of these sensors 32 generates electronic signals that are representative of the associated sensed operating conditions. Additionally, the first embodiment of the apparatus 30 includes one or more user input controls 33 that can be manipulated by a driver or a passenger to regulate the operation of the respective controlled devices 31 within or about the vehicle. For example, the user input controls 33 may include switches or other devices that regulate the operation of heating, ventilating, and/or cooling devices, audio and/or video devices, and the like. Each of these user input controls 33 also generates electronic signals that are representative of the desired operations of the associated controlled devices 31.

The first embodiment of the apparatus 30 also includes one or more conventional electronic control modules 34 (known as vehicle modules) that receive the electronic signals from the sensors 32 and the user input controls 33. The vehicle modules 34 may be provided as original equipment within the vehicle. In response to the electronic signals from the sensors 32 and the user input controls 33, the vehicle modules 34 determine one or more actions that should be taken by one or more of the controlled devices 31. To accomplish this, the vehicle modules 34 send control signals to the controlled devices 31 by means of a vehicle controller area network (CAN) bus 35 or other conventional communications network provided within the vehicle. The controlled devices 31 receive the control signals from the vehicle modules 34, which cause the controlled devices 31 to operate in the desired manners. Additionally, the control signals from the vehicle modules 34 may be sent to one or more conventional display devices 36 provided within the vehicle. These display devices 36 may be used to display a variety of information, such as the operating conditions within or about the vehicle as determined by the sensors 32, the operational statuses of the user input controls 33, and the operational statuses of the controlled devices 31. The structure of the first embodiment of the apparatus 30 thus far described is conventional in the art.

Additionally, the first embodiment of the apparatus 30 further includes one or more personal peripheral devices 37. The personal peripheral device 37 is not part of the original equipment of the vehicle, but rather is an ancillary personal electronic device that is associated with an occupant of the vehicle and that is typically adapted to provide a personal function for the occupant, such as communication (such as a smartphone, for example), timekeeping (such as a smartwatch, for example), and the like. Thus, as used herein, the term “personal peripheral device” is intended to include any electronic device that is adapted to be carried by, worn on, or otherwise transportable with an occupant of the vehicle and that includes an electronic processor 37a for performing a personal function. However, the personal peripheral device 37 may be embodied as any other similar personal electronic device that includes an electronic processor that is capable of interacting with the first embodiment of the apparatus 30 as described below.

The illustrated personal peripheral device 37 includes both personal peripheral device sensors 37b and a personal peripheral device display 37c, although such is not required. The personal peripheral device sensors 37b may be, for example, one or more of an accelerometer, a gyroscope, a magnetometer, a global positioning system component, a proximity sensor, an ambient light sensor, a microphone, a touch screen sensor, and the like. Each of the personal peripheral device sensors 37b generates electronic signals that are representative of the associated sensed operating conditions to the processor contained in the personal peripheral device 37. The processor 37a contained in the personal peripheral device 37 generates electronic signals to operate the smartphone display 37c.

In the first embodiment of the invention shown in FIG. 3, the vehicle modules 34 and the processor 37a contained in the personal peripheral device 37 are arranged for the bidirectional communication of data therebetween. Thus, data from the vehicle modules 34 can be transmitted to the processor 37a contained in the personal peripheral device 37, and data from the processor 37a contained in the personal peripheral device 37 can be transmitted to the vehicle modules 34. Preferably, this transmission of data occurs using a conventional wireless technology standard, although any data transmission mechanism may be used.

Unlike the vehicle modules 14 contained in the prior art apparatus 10 shown in FIG. 1, the vehicle modules 34 of the first embodiment of the apparatus 30 of this invention do not determine what actions should be taken by one or more of the controlled devices 31 in response to the electronic signals from the sensors 32 and the user input controls 33, as described above. Rather, in this first embodiment of the apparatus 30 of this invention, the vehicle modules 34 function merely collect the electronic signals from the sensors 32 and the user input controls 33 and transfer them to the processor 37a contained in the personal peripheral device 37. The processor 37a contained in the personal peripheral device 37 is used to calculate what actions should be taken by the one or more of the controlled devices 31 in response to the electronic signals from the sensors 32 and the user input controls 33, as described above. This is desirable because each of the vehicle modules 34 has a finite capacity for processing the electronic signals from the sensors 32 and the user input controls 33, and each additional vehicle module 34 adds cost and complexity to the vehicle. This invention avoids that undesirable situation by utilizing the processor 37a contained in the personal peripheral device 37 to increase the processing capacity for these electronic signals without requiring that additional vehicle modules 34 be provided as original equipment within the vehicle.

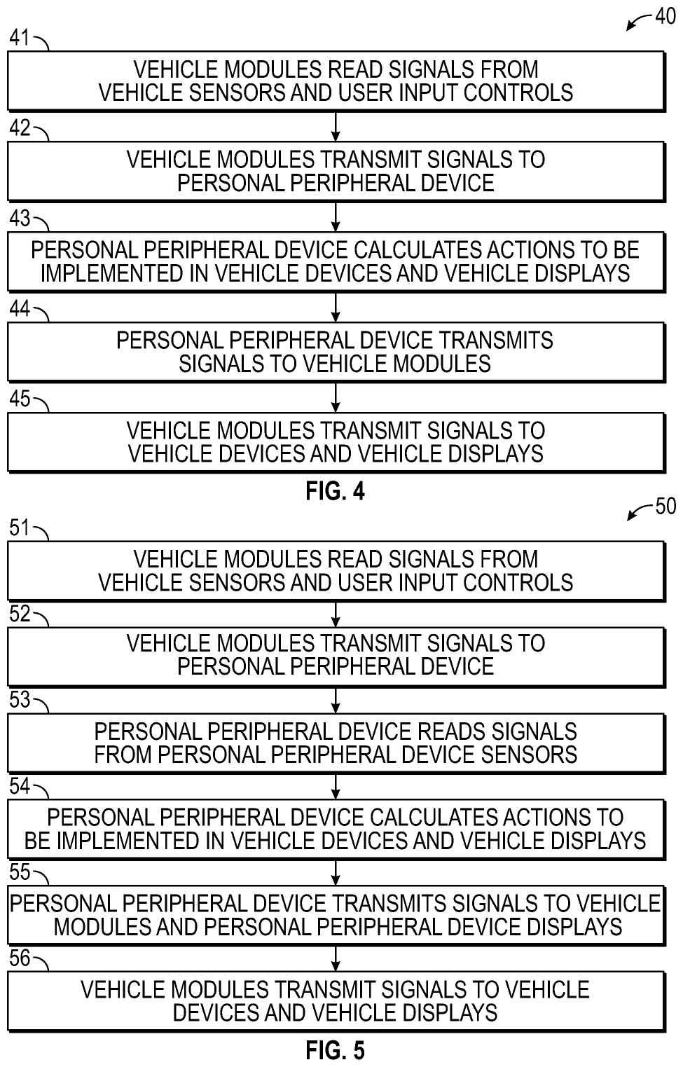

FIG. 4 is a flowchart showing the steps performed in a method, indicated generally at 40, in accordance with this invention for operating the first embodiment of the apparatus 30 illustrated in FIG. 3. In a first step 41 of the method 40, the vehicle modules 34 initially read the various signals that are generated by the vehicle sensors 32 and the user input controls 33. Then, in a second step 42 of the method 40, the vehicle modules transmit the signals from the sensors 32 and the user input controls 33 to the processor 37a contained in the personal processing device 37. Next, in a third step 43 of the method 40, the processor 37a contained in the personal processing device 37 calculates one or more actions to be implemented in the vehicle devices 31 and/or the vehicle displays 36. Such calculations are performed in accordance with a predetermined algorithm in response to the various signals from the vehicle sensors 32 and the input controls 33. Then, in a fourth step 44 of the method 40, the calculated action signals generated by the processor 37a contained in the personal peripheral device 37 are transmitted back to the vehicle modules 34. Lastly, in a fifth step 45 of the method 40 of this invention, the vehicle modules 34 transmit the calculated action signals to the vehicle devices 31 for implementation and/or the vehicle display 36 for display. If desired, the processor 37a contained in the personal processing device 37 can also transmit the calculated action signals to the personal processing device display 37c for display. Alternatively, the vehicle display 36 may be configured to receive a signal directly from the processor 37a contained in the personal peripheral device 37 for controlling the operation of the vehicle display 36.

FIG. 5 is a flowchart showing the steps performed in an alternative method, indicated generally at 50, in accordance with this invention for operating the first embodiment of the apparatus 30 illustrated in FIG. 3. In a first step 51 of the method 50, the vehicle modules 34 initially read the various signals that are generated by the vehicle sensors 32 and the user input controls 33. Then, in a second step 52 of the method 50, the vehicle modules transmit the signals from the sensors 32 and the user input controls 33 to the processor 37a contained in the personal processing device 37. Next, in a third step 53 of the method 50, the processor 37a of the personal processing device 37 reads the various signals that are generated by the personal processing device sensors 37b. In a fourth step 54 of the method 50, the processor 37a contained in the personal processing device 37 calculates one or more actions to be implemented in the vehicle devices 31 and/or the vehicle displays 36. Such calculations are performed in accordance with a predetermined algorithm in response to the various signals from the vehicle sensors 32, the input controls 33, and the personal processing device sensors 37b. Then, in a fifth step 55 of the method 50, the calculated action signals generated by the processor 37a contained in the personal peripheral device 37 are transmitted back to the vehicle modules 34 and to the personal processing device displays 37c for display. Lastly, in a sixth step 56 of the method 50 of this invention, the vehicle modules 34 transmit the calculated action signals to the vehicle devices 31 for implementation and/or the vehicle displays 36 for display.

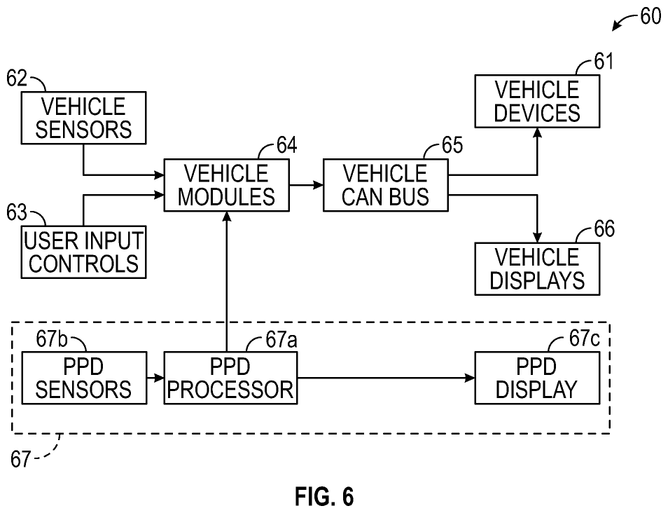

FIG. 6 is a block diagram of a second embodiment of an apparatus, indicated generally at 60, for controlling the operations of one or more controlled devices 61 in a vehicle in accordance with this invention. The second embodiment of the apparatus 60 is, in large measure, identical to the first embodiment of the apparatus 30 illustrated in FIG. 3, and like reference numbers (incremented by 30) are used to designate similar components. However, in the second embodiment of the apparatus 60, the vehicle modules 64 and the processor 67a contained in the personal peripheral device 67 are arranged solely for the unidirectional communication of data therebetween. Thus, data from the processor 67a contained in the personal peripheral device 67 can be transmitted to the vehicle modules 64, but data from the vehicle modules 64 cannot be transmitted to the processor 67a contained in the personal peripheral device 67. As a result, the vehicle modules 64 are the main computational device for the apparatus 60. However, it is still advantageous for the processor 67a contained in the personal peripheral device 67 to collect, organize, and transmit the data from the sensors 67b contained in the personal peripheral device 67 to the vehicle modules 64.

The principle and mode of operation of this invention have been explained and illustrated in its preferred embodiments. However, it must be understood that this invention may be practiced otherwise than as specifically explained and illustrated without departing from its spirit or scope.

What is claimed is:

1. An apparatus for controlling the operation of a controlled device in a vehicle comprising:
a vehicle including a vehicle sensor, a vehicle module that is configured to receive a signal from the vehicle sensor, and a controlled device that is configured to receive a signal from the vehicle module for controlling the operation of the controlled device; and
a personal peripheral device including a personal peripheral device sensor and a processor that is configured to receive a signal from both the personal peripheral device sensor and the vehicle module and, based upon those signals, generate a signal to the vehicle module for generating the signal from the vehicle module for controlling the operation of the controlled device.

2. The apparatus defined in claim 1 wherein the processor of the personal peripheral device and the vehicle module are configured for the bidirectional communication of data therebetween.

3. The apparatus defined in claim 2 wherein the vehicle includes a plurality of vehicle sensors, and wherein the vehicle module is configured to receive a signal from each of the plurality of vehicle sensors.

4. The apparatus defined in claim 2 wherein the personal peripheral device includes a plurality of personal peripheral device sensors, and wherein the processor of the personal peripheral device is configured to receive a signal from each of the plurality of personal peripheral device sensors.

5. The apparatus defined in claim 2 wherein the vehicle includes a display, and wherein the display of the vehicle is configured to receive a signal from the vehicle module for controlling the operation of the display of the vehicle.

6. The apparatus defined in claim 2 wherein the vehicle includes a display, and wherein the display of the vehicle is configured to receive a signal from the processor of the personal peripheral device for controlling the operation of the display of the vehicle.

7. The apparatus defined in claim 2 wherein the personal peripheral device includes a display, and wherein the display of the personal peripheral device is configured to receive a signal from the processor of the personal peripheral device for controlling the operation of the display of the personal peripheral device.

8. The apparatus defined in claim 1 wherein the processor of the personal peripheral device and the vehicle module are configured for the unidirectional communication of data from the processor of the personal peripheral device to the vehicle module.

9. The apparatus defined in claim 8 wherein the vehicle includes a plurality of vehicle sensors, and wherein the vehicle module is configured to receive a signal from each of the plurality of vehicle sensors.

10. The apparatus defined in claim 8 wherein the personal peripheral device includes a plurality of personal peripheral device sensors, and wherein the processor of the personal peripheral device is configured to receive a signal from each of the plurality of personal peripheral device sensors.

11. The apparatus defined in claim 8 wherein the vehicle includes a display, and wherein the display of the vehicle is configured to receive a signal from the vehicle module for controlling the operation of the display of the vehicle.

12. The apparatus defined in claim 8 wherein the personal peripheral device includes a display, and wherein the display of the personal peripheral device is configured to receive a signal from the processor of the personal peripheral device for controlling the operation of the display of the personal peripheral device.

13. A method of controlling the operation of a controlled device in a vehicle comprising the steps of:
(a) providing a vehicle including a vehicle sensor, a vehicle module, and a controlled device;
(b) providing a personal peripheral device including a personal peripheral device sensor and a processor;
(c) sending a signal from the vehicle sensor to the vehicle module;
(d) sending both (1) a signal from the vehicle module that is representative of the signal from the vehicle sensor and (2) a signal from the personal peripheral device sensor to the processor of the personal peripheral device;
(e) sending a signal from the processor of the personal peripheral device to the vehicle module that is representative of a desired action of the controlled device based upon the signal from the vehicle sensor and the signal from the personal peripheral device sensor; and
(f) sending a signal from the vehicle module to the controlled device for controlling the operation of the controlled device.
